(19) United States
(12) Patent Application Publication
(10) Pub. No.: US 2014/0232069 A1
(43) Pub. Date: Aug. 21, 2014

(54) MECHANICAL SEAL WITH A BALANCE SHIFT MECHANISM

(71) Applicant: FLOWSERVE MANAGEMENT COMPANY, Irving, TX (US)

(72) Inventor: Larry E. Jacobs, Kalamazoo, MI (US)

(21) Appl. No.: 14/179,863

(22) Filed: Feb. 13, 2014

Related U.S. Application Data
(60) Provisional application No. 61/765,167, filed on Feb. 15, 2013.

(51) Int. Cl. F16J 15/34

(52) U.S. Cl. CPC F16J 15/34
USPC 277/365

(57) ABSTRACT

An O-ring balance shift mechanism is provided in a dry lift-off face mechanical seal to maintain necessary hydraulic closing forces on the seal faces when pressurized from either the inside or outside diameter of the balance shift mechanism to shift the diameter balance of the seal rings radially under reversed pressure conditions. This mechanism includes a shift ring with two O-rings wherein the shift ring is H-shaped or S-shaped in two alternate embodiments. The O-rings are radially spaced from each other and move axially with the shift ring during reverse pressure conditions.

### CROSS REFERENCE TO RELATED APPLICATIONS

This application asserts priority from provisional application 61/765,167, filed on Feb. 15, 2013, which is incorporated herein by reference.

### FIELD OF THE INVENTION

The invention relates to an improved mechanical seal, and more particularly to a mechanical seal having a balance shift mechanism which accommodates reversed pressure conditions in the seal.

### BACKGROUND OF THE INVENTION

Dry running lift-off mechanical seals or face seals, also called fluid film, gap, or non-contacting face seals, have found application in both gas and liquid sealing applications in compressors and pumps. In these seals, a fluid film forms between the opposing seal faces of two relatively rotatable seal rings. The fluid film between the seal faces allows the seal to operate with minimum heat generation and no wear.

A key feature common to lift-off face seal designs is a radially wide sealing face. This wide surface permits the inclusion of a variety of shallow groove features that create lift between the seal faces, allowing the faces to run without contact. Typically these seal faces are hydraulically balanced in the axial direction through control of the sealing diameter location on the opposite side of the seal ring from the sealing face. In these seals, a first fluid pressure is generated at the respective outside diameter (OD) of each seal face, and a second fluid pressure is generated at the respective inner diameter (ID) of each seal face. As such, these seals are dual pressurized.

Typically, one of the fluid pressures stays higher than the other fluid pressure during normal operation. One of the primary upset conditions that causes failure of dual pressurized lift-off face seals is a reversal of the pressure direction, for example, from inside to outside across the seal face. This upset can be caused either by a loss of the supply of pressure to the seal's barrier cavity or seal chamber on one face diameter, or by an increase in the pressure of the pumped process fluid on the other face diameter. When this reversal occurs, the hydraulic loads on the seal ring change significantly. Depending on the seal design characteristics, the hydraulic load changes resulting from a pressure reversal could cause the seal faces to open to an unacceptably wide operating gap resulting in unacceptable leakage of product fluid across the seal faces. In another scenario, the hydraulic load changes from a pressure reversal could cause the seal faces to have excessive closing force, resulting in undesirable face contact. Due to the relatively wide radial width of lift-off seal faces, significant heat generation results. This can lead to wear and damage of the seal faces and damage of any lift-generating shallow grooves on the seal faces, which will then prevent the seal from returning to normal operation as a lift-off seal due to the damage to the shallow grooves.

A variety of methods are used to control the behavior of the hydraulic closing forces in lift-off seals. In one Flowserve seal sold by the assignee of the present invention, the GX-200 seal includes a patented piston shuttling mechanism (U.S. Pat. No. 5,924,697), which under normal operation utilizes a metal bellows to define a hydraulic sealing diameter. Under reversed pressure operation, the piston shuttling mechanism slides and defines the hydraulic sealing diameter to ensure that the faces close.

In another known seal, this seal utilizes a piston shuttling mechanism in a pusher version of a lift-off seal. In this arrangement, an O-ring is energized by springs and acts as the hydraulic sealing diameter under normal operation. Under reversed pressure operation, a piston shuttling mechanism slides and defines the hydraulic sealing diameter to ensure that the faces close. In this type of mechanism, a normally static O-ring exposed to the process fluid must allow sliding for the hydraulic balance diameter change to occur. If any contamination, solids build up, or other issue causes the O-ring to hang up, the piston shuttling mechanism may not work as effectively and the seal faces may open up to an undesirable degree. Another factor is that the diameters of both piston shuttling mechanisms are such that the hydraulic closing forces will be very high in a reversed pressure operation mode if sliding of the O-ring is impeded. As previously mentioned, this can cause wear and damage to the seal faces.

Another known design is a pusher gas seal, which utilizes a single large cross section O-ring to achieve the needed balance shift. This configuration is similar to many non-lift off designs, which are commercially available. The disadvantage of this arrangement in a lift-off gas seal is that the large O-ring has a higher drag force, and is more susceptible to hang up due to chemical or thermal swell.

Finally, a further known seal uses two bellows capsules of different diameters stacked in a series arrangement to control hydraulic closing forces. Under normal operation, the radially larger bellows is active and defines the hydraulic sealing diameter. Under reversed pressure operation, a shuttling mechanism between the two bellows shifts, activating the smaller diameter bellows and rendering the larger diameter bellows inactive. This causes the smaller diameter bellows to define the hydraulic sealing diameter. One weakness of this mechanism is severely limited axial travel due to the shuttling mechanism, which is advertised as a maximum of +/−0.040″. Many pumps in the application range targeted by these seals have larger axial motion requirements of up to +/−0.125″ due to thermal growth conditions. Another weakness is the size of the seal, which is axially very long due to the stacked bellows arrangement and requires modification of many standard pump designs for the seal to fit. Finally, the cost of this design is comparably higher due to the need for two different sized bellows capsules for one seal size.

The objective of the present invention is to provide an improved design for an O-ring balance shift mechanism, which is provided with a geometry that controls hydraulic closing forces on the seal, effectively allowing the seal to maintain lift both in the normal and reversed pressure directions for the seal. This feature enables the seal to contain and survive pressure reversal conditions with a return to normal operation as a lift off gas seal after such an event.

In the improved seal arrangement of the present invention, the mechanical seal, for example, is pressurized at the inside diameter. This seal contains a mechanism where two O-rings are arranged on a common balance diameter shift ring wherein the shift ring has an H-shaped or S-shaped cross section. In either embodiment, one O-ring has a larger diameter than a smaller diameter O-ring which operates radially inwardly of the larger O-ring. Under normal operation with the high pressure at the inside diameter of the seal, the larger O-ring acts as the primary dynamic sealing element. This allows relative motion between the seal face carrier assembly and the housing to accommodate axial motion within the seal. This O-ring also defines the balance diameter of the seal, also known as the diameter that defines the hydraulic closing force on the seal. The second, smaller diameter O-ring acts as a static sealing element under normal operation. In the event of a reversal of the pressure direction, the entire balance diameter shift ring shifts axially within its groove cavity to a second operative position. In this configuration, after the shift, the larger O-ring becomes a static sealing element, and the smaller diameter O-ring acts as the dynamic sealing element. This effectively shifts the balance diameter to this radial location. This sealing diameter shift is the key feature that enables proper control of hydraulic loads for high pressure at either the inside diameter or outside diameter of the seal face.

An additional element of this design is the provision of a stepped surface on the mating parts of the shift ring and a support ring for one of the seal rings. These steps create an axial space that helps minimize the chances of the shift ring becoming stuck in place due to product solidification or debris, and ensures that pressure gets between the opposed surfaces of stationary support ring and movable shift ring to help shift the mechanism during a pressure reversal.

This invention therefore relates to a new O-ring balance shift mechanism design that is used in a dry lift-off face mechanical seal. The balance shift mechanism is designed to maintain necessary hydraulic closing forces on the seal faces with pressure from either the inside or the outside diameter under normal and reversed pressure operating conditions. Some exemplary design features of this balance shift mechanism are as follows:

1. A shift ring with an H-shaped or S-shaped cross section containing a plurality and preferably, two O-rings.

2. One O-ring seals with external parts at its outside diameter, and the other O-rings seals at its inside diameter.

3. The mechanism allows reversal of pressure direction without affecting the application of spring force to the seal, while maintaining proper hydraulic loading to keep the seal faces closed.

4. The smaller cross section O-rings have lower drag and minimized thermal and chemical swell effects on the seal performance in comparison to a simple thicker O-ring.

With this configuration, an improved mechanical seal is provided which is able to better handle reversed pressure operating conditions.

Other objects and purposes of the invention, and variations thereof, will be apparent upon reading the following specification and inspecting the accompanying drawings.

### BRIEF DESCRIPTION OF THE DRAWINGS

FIG. 1 is a cross-sectional view of an exemplary mechanical seal which includes a balance shift mechanism of the invention using an H-shaped shift ring.

FIG. 2 is an enlarged cross-sectional view of a shift ring assembly comprising one pair of seal rings mounted within the H-shaped shift ring of the invention.

FIG. 3 is a further enlarged view of the stationary seal ring and the balance shift mechanism in a first operative condition.

FIG. 4 is an enlarged view of the balance shift mechanism in the first operative condition.

FIG. 5 is an enlarged view of the balance shift mechanism showing the balance diameter and fluid pressure.

FIG. 6 is a partial view of the seal ring assembly with the balance shift mechanism in a second operative condition occurring under reversed pressure conditions.

FIG. 7 is an enlarged view thereof.

FIG. 8 is an enlarged view of the balance shift mechanism showing the fluid pressures acting thereon.

FIG. 9 is a cross-sectional view of a second embodiment of the invention showing a pair of O-rings seated within an S-shaped shift ring in a first sealing position.

FIG. 10 is a cross-sectional view of a second embodiment of the invention showing the pair of O-rings seated within an S-shaped shift ring in a second sealing position.

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the arrangement and designated parts thereof. Said terminology will include the words specifically mentioned, derivatives thereof, and words of similar import.

### DETAILED DESCRIPTION

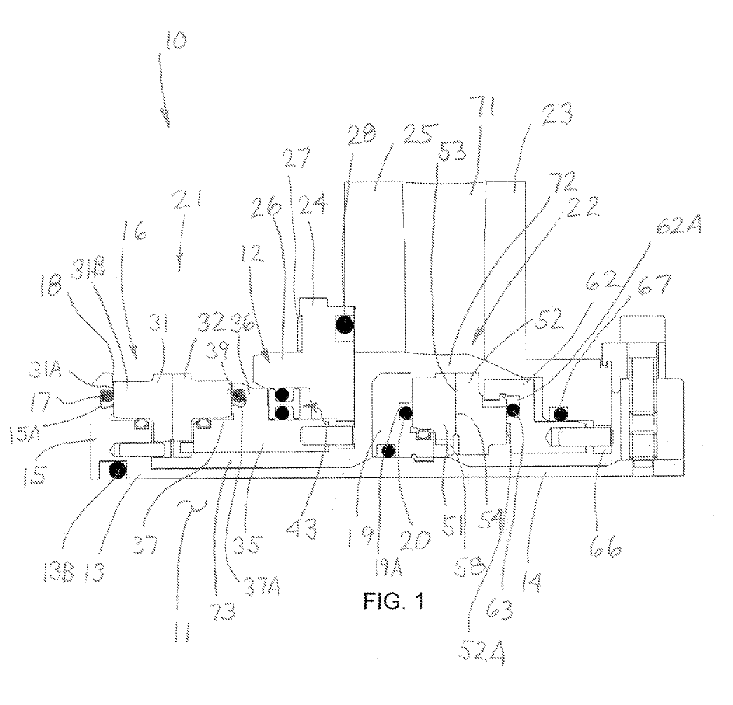

Referring to FIG. 1, there is illustrated a preferred embodiment of a dry lift-off mechanical seal 10 which preferably is provided in a dry gas, mechanical seal that is double pressurized as will be described herein. According to the present invention, this mechanical seal 10 is disposed in concentric relationship to an elongate shaft 11, which is rotatable about its shaft axis so as to rotate during the operation of various types of industrial equipment.

The invention relates to a new O-ring balance shift mechanism 12, which is designed to maintain necessary hydraulic closing forces within the mechanical seal 10 regardless of whether the mechanical seal 10 is operating under a normal pressure condition or a reversed pressure condition. For example, under normal pressure condition a higher pressure is present at the inner diameter, and under a reversed pressure condition, the higher pressure reverses to the outer diameter. The balance shift mechanism 12 allows reversal of pressure direction without affecting the application of spring forces within the mechanical seal 10, while maintaining proper hydraulic loading to prevent seal face opening. Generally, the balance shift mechanism 12 fits between two of the seal components of the mechanical seal 10 and can be provided at different locations with the seal 10.

More particularly, the mechanical seal 10 is provided with a surrounding shaft sleeve 13 nonrotatably secured to the shaft 11 by a set screw (not shown) located on the outboard sleeve end. The mechanical seal 10 mounts adjacent to or within a chamber or stuffing box 16 associated with a housing of the equipment from which the shaft 11 protrudes, such as a pump or compressor. The shaft sleeve 13 includes an annular sleeve body 14 and a backing flange 15 on the inboard sleeve end. The backing flange 15 projects radially outwardly from the shaft 11 and sleeve body 14. The shaft sleeve 13 is sealed against the outer surface of the shaft 11 by an O-ring 13B which defines a secondary seal therebetween. The backing flange 15 also includes an O-ring 17, which is disposed within a gasket groove 15A and acts axially in the area of a ring seat 18, the structure and function of which will be described further hereinafter. While most of the secondary seals provided herein are O-rings, the skilled artisan will also understand that these O-rings may be replaced with other types of appropriate gaskets.

The backing flange 15 is formed on the inboard sleeve end, while an additional backing flange 19 is removably mounted to an outer surface of the shaft sleeve 13 at a location that is spaced axially from the backing flange 15, or in other words, closer to the outboard sleeve end. This backing flange 19 includes a respective O-ring 20, which seats within a respective gasket groove 19A and also acts axially.

To prevent leakage of a process fluid from the process fluid chamber 16 and along the shaft 11, the mechanical seal 10 includes an inner or inboard seal assembly 21, which is positioned more closely adjacent the product being handled, such as the pumping chamber, and an outer or outboard seal assembly 22, which is disposed outwardly of but axially in series with the inner seal assembly 21. These seal assemblies 21 and 22, in the illustrated embodiment, are concentrically mounted on the shaft sleeve 13, such as on the opposite inboard and outboard ends thereof, which sleeve 13 concentrically surrounds and is nonrotatably fixed relative to the shaft 11 as described above.

Upon mounting the mechanical seal 10 to a piece of rotating equipment, such as a pump or compressor, the mechanical seal 10 projects partially into the chamber 16, with the outer portion of the seal arrangement 10 being disposed within and surrounded by a gland or housing part 23. In the illustrated embodiment, the gland 23 is defined by a pair of gland rings 24 and 25 which axially and sealingly abut one another. The rings 24 and 25 are axially secured together and fixedly and sealingly positioned relative to the equipment housing by suitable fasteners.

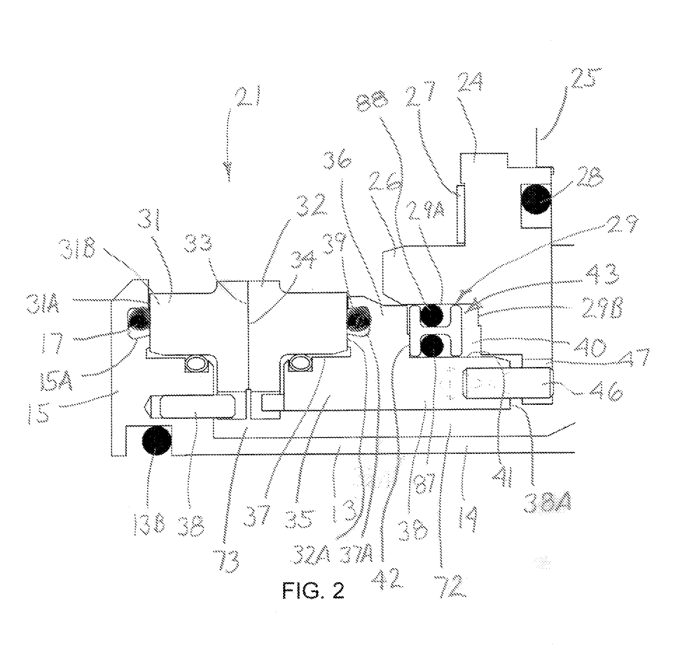

The inner gland ring 24 has an annular hub part 26, which telescopes into the outer end of chamber 16 so as to be positioned in surrounding relationship to an outboard end portion of the inner seal assembly 21. A gasket 27 cooperates between the equipment housing and gland ring 24 for creating a sealed relationship therebetween, and an O-ring 28 defines a secondary seal between the gland rings 24 and 25. As seen in FIG. 2, the hub part 26 of the inner gland ring 24 has an annular channel 29 which is defined by a channel side face 29A which faces radially-inwardly, and a channel end face 29B which faces axially-inwardly toward the inboard sleeve end.

Referring now to the inner seal assembly 21 as seen in FIGS. 1 and 2, this seal assembly 21 includes a rotating seal ring (a rotor) 31 and a stationary seal ring (a stator) 32 which substantially concentrically surround the shaft 11 and respectively define thereon flat annular seal faces 33 and 34 maintained in abutting relative rotatable, separable contact with one another to create a seal between the regions disposed radially inwardly and outwardly thereof. When the shaft 11 is not rotating, the seal faces 33 and 34 are spring-biased into sealing contact with each other to define a static seal. To affect sealing during shaft rotation, at least one of the seal faces 33 and 34 includes a conventional hydrodynamic lift feature such as shallow spiral grooves which generate formation of a fluid film between the seal faces 33 and 34 during shaft rotation. Each of the seal faces 33 and 34 is defined by respective inner and outer diameters wherein the opposing portions of the seal faces 33 and 34 define a sealing region which extends radially across the seal faces 33 and 34. In the illustrated embodiment, the seal faces 33 and 34 have substantially the same radial width such that the sealing region extends across the entirety of both seal faces 33 and 34. It will be understood that the seal faces may have different radial widths and positions relative to each other, such that the overall radial width of the sealing region can vary depending upon the geometry and dimensional relationships of the seal faces and the amount of radial overlap that one seal face overlaps the other seal face.

To support the rotor 31, the above-described backing flange 15 externally surrounds and is nonrotatably formed with the shaft sleeve 13 so as to rotate therewith. The backing flange 15 defines the recessed seat 18 in which the rotator 31 is supported, wherein the O-ring 17 is sealingly engaged with a back face 31A of the seal ring 31. The back face 31A is defined by a rearwardly projecting annular hub portion 31B of the rotor 31, wherein the backing flange 15 seals against the back face 31A through the intermediate elastomeric O-ring 17, which abuts against the back face 31A. One or more drive pins 38 are fixed to the backing flange 15 in angularly spaced relationship therearound, and project axially therefrom into respective recesses formed in the rotor 31 so as to nonrotatably connect the rotor 31 to the backing flange 15. As such, the rotor 31 rotates in unison with the shaft sleeve 13 and shaft 11 such that this rotor 31 is referred to as the rotating seal ring.

As to the stator 32, the inner seal assembly 21 includes an annular support ring 35, which carries the stator 32 on the inboard end thereof. The support ring 35 has a radial flange 36, which projects radially outwardly and axially separates an inboard ring seat 37 from an outboard end wall 38 of the support ring 35. The ring seat 37 includes a gasket groove 37A and an O-ring 39, which is located within the gasket groove 37A and abuts against a back face 32A of the stator 32 to define a secondary seal thereat. The stator 32 structurally interfits with the ring seat 37 so as to be held stationary relative to the support ring 35 during shaft rotation while moving axially in unison with the support ring 35.

The outboard end wall 38 projects axially in the outboard direction and has a stepped cylindrical channel 40, which opens radially outwardly and axially toward the outboard sleeve end. The end wall 38 is axially, slidably accommodated within the hub part 26 of the inner gland ring 24 so that the channel 40 faces the gland ring 24. As seen in FIG. 2, the ring channel 40 generally corresponds to and is disposed in opposing relation with the channel 29 of the hub part 26 of the inner gland ring 24. The ring channel 40 is defined by a radially-outward facing channel side face 41 and an axially-outboard facing channel end face 42. The opposed side faces 30 and 41 and end faces 31 and 42 of the support ring 35 and gland ring 24 define an annular chamber 43 therebetween. As will be described herein, the inventive balance shift mechanism 12 is accommodated within the chamber 43 to create a sealed relationship between the stator 32/support ring 35 and the inner gland ring 24. This balance shift mechanism 12 is normally abuts against the channel end face 42 of the support ring 35 when the barrier fluid chamber 72 between the inner and outer seal assemblies 21 and 22 is provided with a higher pressure barrier gas therein, as explained hereinafter.

Further as to the support ring 35 as seen in FIG. 2, the annular end wall 38 has an end face 38A which includes one or more drive pins 46 fixed thereto at angularly spaced intervals, which pins 46 project axially into recesses 47 formed in the inner gland ring 24. The pins 46 nonrotatably couple the support ring 35 and its associated stator 32 to the gland ring 24 so that the stator 32 is also referred to as the stationary seal ring since it does not rotate during shaft rotation. However, the stator assembly of the support ring 35 and stator 32 is still axially movable relative to the gland ring 24 as discussed below. In this regard, additional recesses (not shown) are formed in the outer end face 38A of the support ring 35 in circumferentially spaced relationship, wherein these recesses accommodate springs which react axially between the support ring 35 and the inner gland ring 24 so as to always resiliently bias the stator 32 axially toward the rotor 31 and thereby maintain contact between the seal faces 33 and 34 when the shaft 11 is not rotating. However, during shaft rotation, the springs permit limited axial movement of the stator assembly, i.e. the support ring 35 and stator 32, away from the rotor 31. As such, the hydrodynamic face pattern generates a lifting force between the seal faces 33 and 34, which allows the seal faces 33, and 34 to separate slightly and then remain separated due to the presence of a fluid film forming therebetween. The lifting force and the fluid film tend to generate opening forces, which tend to separate or open the seal faces 33 and 34. These opening forces are counterbalanced by closing forces which comprise the spring force of the springs or other similar biasing means, and the pressurized barrier fluid which tends to close the seal faces 33 and 34 during normal operation.

Referring to FIG. 1, the outer seal assembly 22 is of similar construction in that it includes a rotating seal ring (a rotor) 51 and a stationary seal ring (a stator) 52 which respectively have flat annular seal faces 53 and 54 maintained in relatively rotatable sliding engagement with one another to maintain a seal between the regions disposed radially inwardly and outwardly thereof. The rotor 51 seats within the backing flange 19 so that the rotor 51 externally surrounds and is sealingly engaged relative to the shaft sleeve 13 through the elastomeric O-ring 20 disposed between the rotor 51 and backing flange 19. The backing flange 19 surrounds and is fixedly secured to the shaft sleeve 13 and also interfits with recesses 58 formed in the rotor 51 to nonrotatably couple the rotor 51 to the shaft 11. Further, the backing flange 19 includes a gasket groove 19A which receives the O-ring 20 therein.

The stator 52 is stationarily positioned within an annular support ring 62 with an elastomeric seal ring or O-ring 63 coacting therebetween for creating a sealed relationship. The support ring 62 includes a gasket groove 62A which receives the O-ring 63 therein, wherein the stator 52 has a rear face 52A which abuts against the O-ring 63. The support ring 62 has a plurality of pins 65 which are secured to the gland ring 25 and project axially therefrom into recesses 66 for nonrotatably securing the stator 52 relative to the gland ring 25. An elastomeric O-ring 67 defines a secondary seal between the gland ring 25 and the support ring 62. As such, the stator 52 also is stationary in that it does not rotate during shaft rotation, but is also spring biased toward and movable away from the rotor 51 to permit formation of a fluid film between the seals faces 53 and 54 during shaft rotation.

The seal rotor 51 and stator 32 are normally constructed of a carbon composition, whereas the stator 52 and rotor 31 are normally constructed of a harder material such as tungsten carbide.

To provide a barrier gas between the inner seal assembly 21 and the outer seal assembly 22, the gland 23 has an opening 71 formed radially therethrough for communication with an annular chamber 72. The chamber 72 is defined interiorly of the gland 23 in surrounding relationship to at least a part of the mechanical seal 10. This annular chamber 72, which is the barrier gas chamber as explained below, surrounds the outer seal assembly 22 and also includes an annular chamber portion 73 which is located internally of the stator 32 associated with the inner seal assembly 21. To supply a pressurized barrier gas such as air or nitrogen to the chamber 72, the inlet opening 71 is normally coupled to a supply line, the inlet of which is coupled to a conventional source of an inert pressurized barrier gas. This supply line contains many of the usual flow control elements associated therewith. In this respect, the rotor 31 and stator 32 are configured to communicate with the subchamber 73 so as to permit barrier gas to reach and contact the inner diameters of the seal faces 33 and 34 to provide for desired balancing of barrier gas pressure on opposite ends of the axially-movable stator 32 so as to control the contact pressure between the seal faces 33 and 34. The barrier gas also flows to and reaches the outer diameters of the seal faces 53 and 54 of the outer seal assembly 21.

Since the barrier gas can reach the seal faces 33 and 34, the hydrodynamic lift features on the seal faces 33 and 34 are able to receive this barrier gas into the sealing region and thereby form a fluid film during shaft rotation. Similarly, the barrier gas also reaches the outer seal assembly 22 and the barrier gas is able to form a fluid film between the seal faces 53 and 54. The barrier gas essentially is trapped between the seal assemblies 21 and 22 and is maintained at a higher pressure than the process fluid being sealed within the seal chamber 16 by the inboard seal assembly 21 and is maintained at a higher pressure than ambient or external atmosphere located on the outboard, external side of the seal assembly 22.

In operation, the inert pressurized barrier gas is supplied into the annular chamber 72, with the barrier gas being at an elevated pressure. The pressure of the barrier gas is greater than the pressure of the product within the stuffing box chamber 16, which product pressure is being sealed by the inner annular seal assembly 21. In fact, the pressure differential across the outer seal assembly 22 can be greater since this outer seal assembly 22 cooperates with the ambient atmosphere which typically is not under pressure.

In more detail as to the inner seal assembly 21, the barrier gas occupies the annular subchamber 73 to act against portions of both the axial rear and front faces of the rotor 31 to maintain a significant degree of pressure balance thereon to prevent excessive contact pressure between the seal faces 33 and 34. The pressurized barrier gas also enters into the chamber 43 and acts against the balance shift mechanism 12 so as to urge the latter into abutting engagement with the end face 42 on the support ring 35 wherein the balance shift mechanism 12 sealingly isolates the barrier gas from the product in the chamber 16. The presence of the pressurized barrier gas adjacent the inner diameter of the seal face 34, results in the pressure adjacent the inner diameter of the seal face 34 being greater than the product pressure which exists at the outer diameter of the seal face 34. If any leakage occurs between the seal faces 33 and 34, then such leakage will be leakage of the barrier gas radially outwardly between the seal faces, which barrier gas will mix with the product in the chamber 16, which is permissible to a certain degree. In this fashion, the escape of product exteriorly of the seal assembly 21 can be effectively prevented with a high degree of efficiency, and the escape of harmful product emissions externally of the seal 10 can be effectively prevented to a very high degree.

At the same time, the outer seal assembly 22 maintains a seal between the barrier gas within the chamber 72 and the surrounding environment both so as to maintain the pressurized barrier gas between the two seal assemblies 21 and 22, and to function as a redundant seal to prevent escape of product into the environment in the event of a significant failure of the inner seal assembly 21.

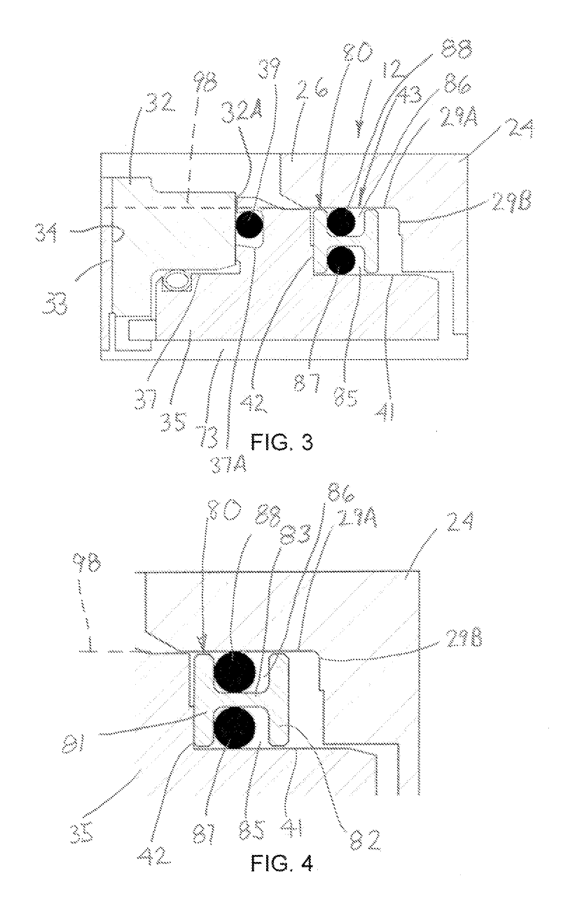

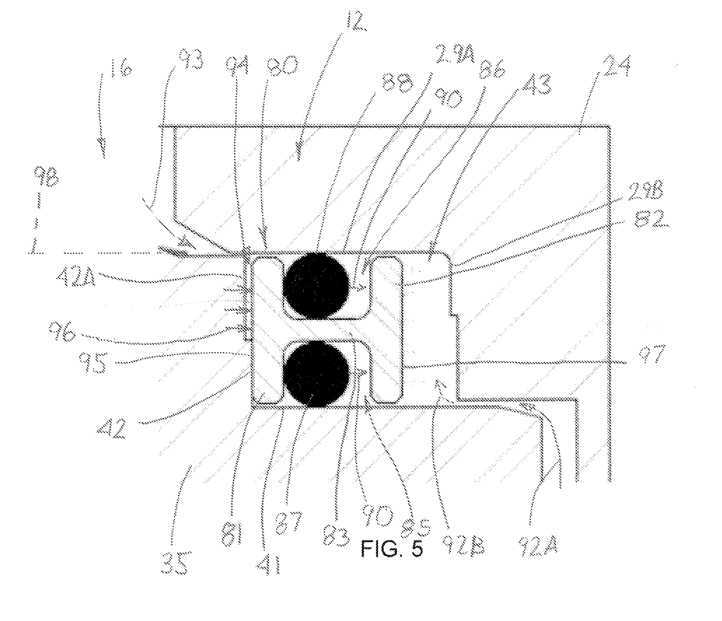

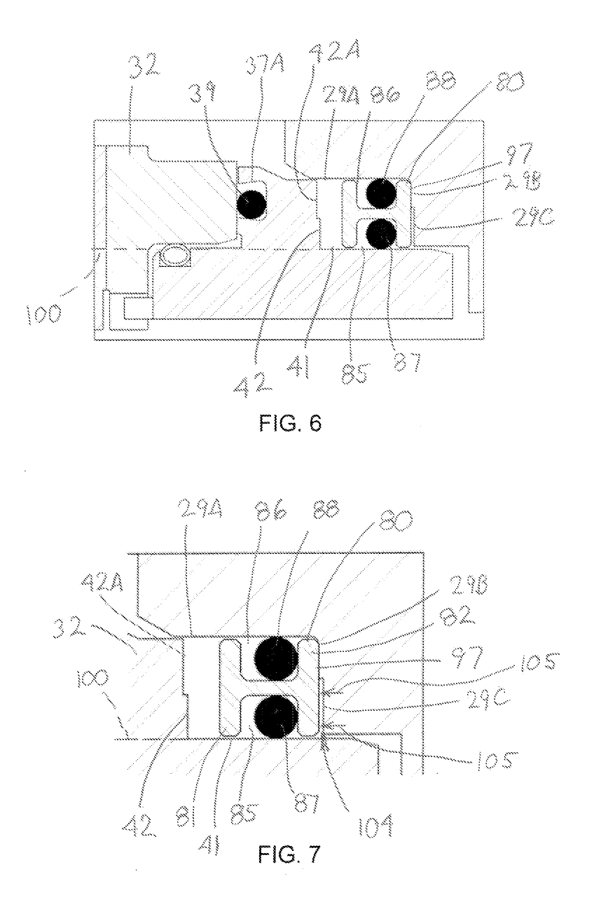

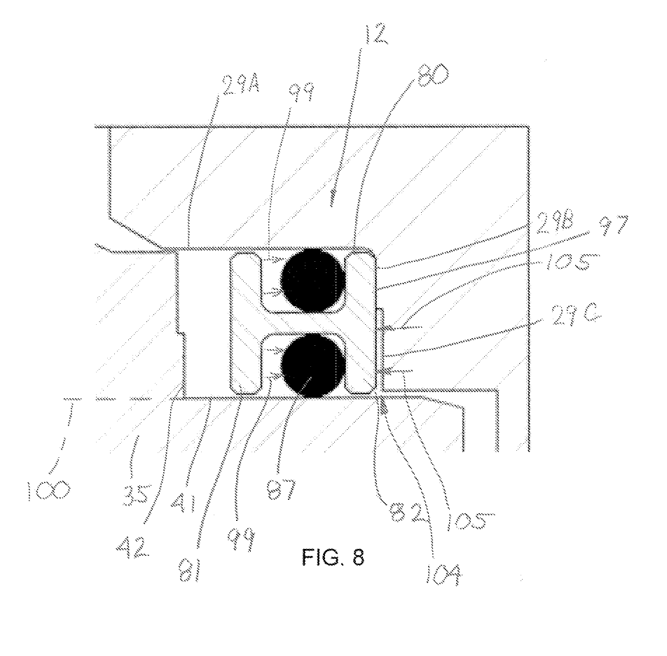

More particularly with respect to the balance shift mechanism 12, the mechanism 12 is slidably received within the annular chamber 43 so that it is slidable axially therein. As such, the balance shift mechanism 12 fits between two seal components wherein the seal components in the preferred embodiment are the gland ring 24 and support ring 35. It will be understand the mechanism 12 can be used between other pairs of seal components. Generally, the mechanism 12 comprises balance shift ring 80 which fits within the chamber 43 and is axially slidable between a first operative position shown in FIGS. 3-5, and a second operative position shown in FIGS. 6-8. As to the first operative position of FIGS. 3-5, the shift ring 80 is shown in a first embodiment with a capital H-shaped cross-sectional shape defined by radially extending sidewalls 81 and 82 and an intermediate web 83 which axially joins the sidewalls 81 and 82 together to thereby define inner and outer gasket channels 85 and 86. Each of the gasket channels 85 and 86 includes a respective elastomeric sealing gasket 87 and 88 which gaskets 87 and 88 preferably are formed as elastomeric O-rings. The diameter of the inner gasket 87 is smaller than the larger outer gasket 88 so that it is disposed radially inwardly of the outer gasket 88. In the illustrated embodiment, the inner gasket 87 and outer gasket 88 are radially adjacent and axially aligned with each other. The cross-sectional thickness of each gasket 87 and 88 is substantially the same, but is smaller than the axial length of the gasket channels 85 and 86 which thereby allows each of the gaskets 87 and 88 to displace axially within their respective channels 85 and 86 from a first sealing position shown in FIGS. 4 and 5 to a second sealing position shown in FIGS. 7 and 8. The axial displaceability of gaskets 87 and 88 is generally indicated by reference arrows 90 in FIG. 5.

Referring to FIG. 5, when the shift ring 80 is in the left operative position, the shift ring 80 abuts against the channel end face 42 such that any leftward directed fluid forces generated by the barrier fluid within the shift ring 80 act axially against the surface 42. More particularly, the shift mechanism 12 is acted upon by the different fluid pressures being generated on the seal outer diameter by the process fluid and on the seal inner diameter by the barrier fluid. Normally, the barrier fluid pressure is higher than the process fluid pressure such that the net fluid forces bias the shift mechanism 12 to the left and generate a component of the closing forces acting to close the seal faces 33 and 34.

More particularly, sufficient clearance spacing is provided between the inner gland 24 and the support ring 35 so that the higher pressure barrier fluid can flow into the annular channel 43 through a flow path generally indicated by arrows 92A and 92B in FIG. 5. In turn, the lower pressure process fluid is able to act on the opposite side of the shift mechanism by flowing through a flow path generally indicated by reference arrow 93 in FIG. 5.

With respect to the end face 42, this end face 42 is stepped axially so as to define a recess 94 extending across a partial radial width of the end face 42. This recess 94 thereby is defined axially between an end face portion 42A and an opposing wall face 95 of the ring wall 81. This clearance space 94 allows the fluid pressure of the process fluid in chamber 16 to act axially rightwardly in FIG. 5 on at least a portion of the wall face 95 as indicated by reference arrows 96. However, under a normal operating condition shown in FIG. 5, the inside diameter barrier fluid is at a higher pressure than the process fluid so that this higher pressure drives the shift ring 80 leftwardly to the position of FIG. 5. In more detail, the barrier fluid enters the channel 43 through the flow paths 92A and 92B and flows about the wall face 97 of the rightward ring wall 82. Additional spaces are provided between the upper and lower ends of the wall 82 which ends face radially inwardly and outwardly toward the channel side faces 41 and 30 so that the high pressure barrier fluid can flow into the gasket channels 84 and 86 and drive the gaskets 87 and 88 to the left as seen in FIG. 5. Because this fluid pressure acts across substantially the entire radial width of the balance shift mechanism 12, this applies a leftwardly directed fluid pressure to the support ring 35 and to the seal ring 32 which contributes to the closing forces acting on the stator 32.

Since the shift ring 80 is stopped at the channel end face 42, the shift ring 80 remains stationary during normal operation even if the assembly of the seal ring 32 and support ring 35 move axially in response to normal seal operation which occurs due to axial motion within the seal rings 31 and 32. As such, the inner O-ring 87 remains stationary relative to the support ring 35 and defines a static sealing element. The outer O-ring 88 is able to slide along the outer channel face 29A in response to axial movement of the seal parts 32 and 35 and thereby defines a dynamic sealing element.

The outward radial limit that this high pressure acts is defined by the contact between the outer or larger gasket 88 and the outer channel side face 29A which thereby defines a balance diameter for the seal 10 indicated by reference line 98 in FIGS. 3-5. Since the balance diameter 98 is disposed to a significant extent radially outwardly relative to the seal rings 31 and 32, the high pressure barrier fluid creates a fluid pressure which tends to create a closing force that tends to resist opening of the seal faces 33 and 34 during normal seal operation. During such normal seal operation, the fluid film forms between the seal faces 33 and 34 and creates a significant enough opening pressure so as to allow separation of the seal rings by axial displacement of the seal ring 32 and its support ring 35 to the right to a limited extent. The opening force between the seal faces 33 and 34 is balanced against the spring forces and the hydraulic closing forces generated by the barrier fluid, which combination of forces controls the magnitude of the gap between the seal faces 33 and 34. As such, this permits limited separation of the seal faces 33 and 34 wherein a limited amount of barrier fluid is pumped into the process fluid by the hydrodynamic face features. However, excessive seal face separation does not occur during normal operating conditions, wherein the barrier fluid pressure is sufficiently higher than the process fluid pressure.

However, as previously discussed above, a reversed pressure condition can occur during seal operation due to various factors. This reversed pressure condition can occur if the process fluid pressure increases or spikes relative to the barrier fluid pressure, for example, during upset conditions within the equipment. Alternatively, the process fluid pressure may remain at normal conditions but there may be a sudden loss in barrier fluid pressure due to a mechanical breakdown or other unexpected occurrence. As such, the barrier fluid pressure then may drop so that it is less than the process fluid which also creates a reversed pressure condition for the mechanical seal 10 since the higher pressure side has now reversed from the inner seal diameter to the outer diameter. It will be understood that FIG. 1 is a representative seal and that it is known in other seal configurations to provide the higher pressure barrier fluid on the outer seal face diameter with the process fluid being present on the inner diameter. The balance shift mechanism 12 can be readily adapted for this alternate seal configuration.

As discussed above in the Background, reverse pressure conditions must be accommodated to avoid the circumstance where the reverse pressure condition increases the opening forces between the seal faces 33 and 34 and allows leakage of the process fluid into the barrier fluid chamber 72. The balance shift mechanism 12 of the invention is able to accommodate reverse pressure conditions as described below since the shift ring 80 is able to move rightwardly to the second operative position shown in FIG. 6-8 during a reversed pressure condition.

In the reversed pressure condition, the process fluid pressure acting rightwardly on the shift mechanism 12 then exceeds the barrier fluid pressure, which is acting leftwardly on the mechanism 12 as generally shown in FIG. 5. Without the balance shift mechanism 12, the net opening forces could then exceed the net closing forces. However, when this process fluid pressure exceeds the barrier fluid pressure, the higher process fluid pressure is able to move the shift ring 80 and the associated gaskets 87 and 88 to the right which changes the pressure balancing occurring within the mechanical seal 10. More particularly, the high pressure process fluid still flows through the flow path 93 and migrates into the space 94, and also flows about the terminal ends of the inboard wall 81 into the region of the gaskets 87 and 88. Hence, the process fluid pressure acts on the inboard side of the gaskets 87 and 88 within the channels 85 and 86 now is greater than the barrier fluid pressure acting on the opposite outboard sides of the gaskets 87 and 88. The rightwardly directed fluid pressure is generally indicated by reference arrows 99 in FIG. 8. This causes the gaskets 87 and 88 to simultaneously shift rightwardly as indicated by arrows 90 to the rightward sealing position as seen in FIGS. 6-8 so that the gaskets 87 and 88, as well as the shift ring 80 move together to the rightward second operative position of FIGS. 6 and 7.

In this condition, the higher process fluid pressure acts on the support ring 35 radially inwardly to a shifted balance diameter 100 indicated in FIG. 6-8. The shifted balance diameter 100 is essentially defined by the sealing contact between the smaller gasket 87 and the channel side face 41 as seen in FIGS. 7 and 8. This increases the net closing force acting upon the support ring 35 and associated seal ring 32 which increases the tendancy to maintain the seal faces 33 and 34 in a closed condition. By appropriate balancing of the opening forces generated by the fluid film and the closing forces generated by the process fluid, excessive leakage through the seal faces 33 and 34 to the barrier fluid chamber 72 is prevented by this shift mechanism 12 even under reversed pressure conditions.

Since the shift ring 80 is now stopped at the opposite channel end face 29B, the shift ring 80 remains stationary in the second operative position during upset conditions even though the assembly of the seal ring 32 and support ring 35 cab still move axially relative to the inner gland ring 24 due to axial motion within the seal rings 31 and 32. In this shifted condition, the outer O-ring 88 remains stationary relative to the gland ring 24 and defines the static sealing element. The inner O-ring 87 now is able to slide along the inner channel side surface 41 in response to axial movement of the seal parts and thereby defines the dynamic sealing element.

To further increase the closing forces, the O-rings 17 and 39 (FIG. 2) are also shiftable radially in their respective gasket grooves 15A and 37A. Under normal operating conditions, the higher barrier fluid pressure biases the O-rings 17 and 39 radially outwardly to the outer side of the grooves 15A and 17A. This increases the area on the back side of the seal rings 31 and 32 which is subjected to the barrier fluid pressure and decreases the contact forces between the support surfaces defined by the seal back face 32A and support ring 35 and the seal back face 31A and backing flange 15. In the reversed pressure condition of FIG. 6, the higher process fluid pressure drives the O-ring 39 radially inward by compression of the elastomeric material, which then shifts the O-ring 39 toward the inner side of the groove 37A. This O-ring shift then increases the area that the process fluid pressure acts to generate a closing force on the seal ring 32. Similarly, the O-ring 17 would shift inwardly due to compression toward the inner side of the gasket groove 15A to also adjust the closing force acting on the seal ring 31.

As an additional element of the balance shift mechanism 12, the end faces 29B and 42 of the channel 43 are stepped to create axial spaces that help minimize the chances of the shift ring 80 becoming stuck in place due to product solidification or debris, and to ensure that the higher pressure fluid flows between the opposed surfaces of the stationary support ring 35 or inner gland ring 24 and the movable shift ring 80 to help initiate shifting of the mechanism during a pressure reversal or a return to normal operating conditions.

More particularly, the above discussion described that the channel end face 42 is stepped as seen in FIG. 5 wherein the stepped portion 42A defines the clearance space 94. Similarly, the channel end face 29B is also stepped at an end face portion 29C. This end face 29B is stepped axially so as to define a recess 104 extending across a partial radial width of the end face 29B as defined by the end face portion 29C. This recess 104 thereby is defined axially between the end face portion 29C and the opposing wall face 97 of the outboard ring wall 82. This clearance space 104 allows the fluid pressure of the barrier fluid to act axially leftwardly in FIG. 7 on at least a portion of the wall face 97 as indicated by reference arrows 105.

Referring to FIG. 5, when there is a pressure reversal, the higher pressure process fluid is able to flow more readily into the clearance space 94 and between the wall face 95 and stepped portion 42A to make it easier to drive the shift ring 80 to the right. Similarly as to FIG. 7, when the barrier fluid pressure returns to a normal condition greater than the process fluid pressure, the higher pressure barrier fluid is able to flow more readily into the clearance space 104 and between the wall face 105 and stepped portion 29C to make it easier to drive the shift ring 80 back to the left.

According to this preferred embodiment of the seal 10, the improved design for the O-ring balance shift mechanism 12 has an H-shaped cross-sectional geometry that controls hydraulic closing forces on the seal faces 33 and 34 which effectively allows the seal faces 33 and 34 to maintain lift or provide a controlled closing force both in the normal and reversed pressure directions for the seal. This feature enables the seal to contain and survive pressure reversal conditions with a return to normal operation as a lift off gas seal after such an event.

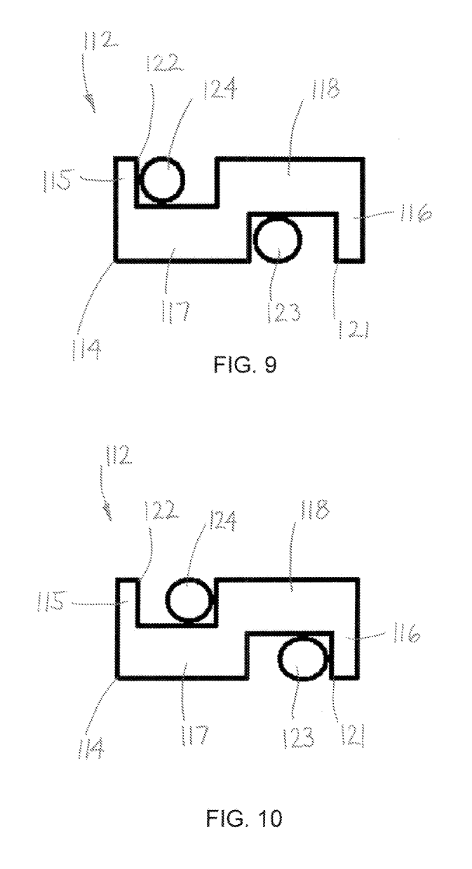

A second embodiment of the balance shift mechanism is seen in FIGS. 9 and 10 and designated by reference numeral 112. This embodiment functions the same as shift mechanism 12 except that it has a generally S-shaped configuration having axially offset O-rings. The mechanism 112 comprises a balance shift ring 114 which fits within the chamber 43 and is axially slidable therein between a first operative position similar to that shown in FIGS. 3-5, and a second operative position similar to that shown in FIGS. 6-8. The S-shaped shift ring 114 is defined by radially extending sidewalls 115 and 116 and intermediate webs 117 and 118 which axially join the sidewalls 115 and 116 together to thereby define inner and outer gasket channels 121 and 122. Each of the gasket channels 85 and 86 includes a respective elastomeric sealing gasket 123 and 124 which preferably are formed as elastomeric O-rings but are not limited to an O-ring type gasket structure. Other gasket structures may also be suitable. The diameter of the inner gasket 123 is smaller than the larger outer gasket 124 so that it disposed radially inwardly of the outer gasket 88. In the illustrated embodiment, the inner gasket 123 and outer gasket 124 are radially adjacent but axially offset with each other. Preferably, the cross-sectional thickness of each gasket 123 and 124 is substantially the same, but is smaller than the axial length of the gasket channels 121 and 122 which thereby allows each of the gaskets 123 and 124 to displace axially within their respective channels 121 and 122 from a first sealing position (FIG. 9) to a second sealing position (FIG. 10). The axial displaceability of gaskets 123 and 124 functions the same as gaskets 87 and 88 described above. If appropriate, the cross-sectional thickness of each gasket 123 and 124 could also be different, yet still allow for axial displacement of the gaskets 123 and 124.

In accord with the above discussion, when the shift ring 114 is in the left operative position, the shift ring 114 would abut against the channel end face 42 such that any leftward directed fluid forces generated by the barrier fluid within the shift ring 114 act axially against the end face 42. In this operative position, the gaskets 122 and 123 are in the leftward, first sealing position of FIG. 9. Conversely, in a reverse pressure condition, the shift ring 114 would shift to the second operative position acting against channel end face 29B wherein the gaskets 122 and 123 are shifted to the rightward, second sealing position of FIG. 10. The above discussion of shift mechanism 12 is also applicable to shift mechanism 112 and further discussion thereof is not required.

Although particular preferred embodiments of the invention have been disclosed in detail for illustrative purposes, it will be recognized that variations or modifications of the disclosed apparatus, including the rearrangement of parts, lie within the scope of the present invention.

What is claimed:

1. In a mechanical seal for sealing an annular sealing space between a housing and an axially-elongated rotatable shaft, said mechanical seal including a plurality of annular seal components surrounding said shaft wherein said seal components comprise at least a non-rotatable first seal ring, a first support member for said seal ring, and a rotatable second seal ring non-rotatably mounted on said shaft so as to rotate therewith, said first and second seal rings having opposing seal faces which sealingly separate a first chamber with a first pressurized fluid at a first fluid pressure from a second chamber with a second pressurized fluid at a second fluid pressure different than said first fluid pressure, comprising the improvement wherein:
a secondary seal is provided between a first said seal component and a second said seal component to prevent leakage between said first and second chambers, said first and second seal components having respective first and channel portions wherein said first and second channel portions open toward each other and together define an annular channel formed radially and axially between said first and second seal components; and
said secondary seal comprising a balance shift mechanism disposed within said annular channel which comprises a shift ring which is received in said annular channel and has opposite ends respectively exposed to said first and second pressurized fluids which move said shift ring between first and second operative positions, said shift ring further including inner and outer gaskets which face in opposite inward and outward radial directions to sealingly contact said first and second seal components, said shift ring being movable by a relative pressure difference between said first and second fluid pressures so as to be in said first operative position in contact with said first seal component when said first fluid pressure is higher than said second fluid pressure, and be in said second operative position in contact with said second seal component when said second fluid pressure is higher than said first fluid pressure.

2. The mechanical seal according to claim 1, wherein said outer gasket defining a first balance diameter of said first and second seal rings when said shift ring is in said first operative position, and said inner gasket defining said balance diameter when said shift ring is in said second operative position.

3. The mechanical seal according to claim 2, wherein said balance diameter shifts radially inwardly as said shift ring moves axially from said first operative position to said second operative position.

4. The mechanical seal according to claim 3, wherein said balance diameter shifts radially outwardly as said shift ring moves axially from said second operative position to said first operative position.

5. The mechanical seal according to claim 2, wherein said balance diameter shifts radially outwardly as said shift ring moves axially from said second operative position to said first operative position.

6. The mechanical seal according to claim 1, wherein said shift ring includes inner and outer gasket channels which receive said inner and outer gaskets therein.

7. The mechanical seal according to claim 6, wherein said inner and outer gasket channels are each defined by axially spaced side faces which define an axial length of each of said inner and outer gasket channels which is greater than a thickness of said inner and outer gaskets such that said inner and outer gaskets are each displaceable axially within said inner and outer gasket channels between first and second sealing positions.

8. The mechanical seal according to claim 7, wherein said inner and outer gaskets are shifted to said first sealing position when said first fluid pressure is greater than said second fluid pressure, and are shifted to said second sealing position when said second fluid pressure is greater than said first fluid pressure.

9. The mechanical seal according to claim 8, wherein said inner and outer gaskets shift axially to said second sealing position as said shift ring shifts axially to said second operative position.

10. The mechanical seal according to claim 9, wherein inner and outer gaskets shift axially to said first sealing position as said shift ring shifts axially to said first operative position.

11. In a mechanical seal for sealing an annular sealing space between a housing and an axially-elongated rotatable shaft, said mechanical seal including a plurality of annular seal components surrounding said shaft wherein said seal components comprise at least a non-rotatable first seal ring, a first support member for said seal ring, and a rotatable second seal ring non-rotatably mounted on said shaft so as to rotate therewith, said first and second seal rings having opposing seal faces which sealingly separate a first chamber with a first pressurized fluid at a first fluid pressure from a second chamber with a second pressurized fluid at a second fluid pressure different than said first fluid pressure, said first and second fluid pressures acting on said seal components to define a balance diameter relative to said first and second seal faces, comprising the improvement wherein:
a secondary seal is provided between a first said seal component and a second said seal component to prevent leakage between said first and second chambers, said first and second seal components having respective first and channel portions wherein said first and second channel portions open toward each other and together define an annular channel formed radially and axially between said first and second seal components; and
said secondary seal comprising a balance shift mechanism disposed within said annular channel which comprises a shift ring which is received in said annular channel and has opposite ends respectively exposed to said first and second pressurized fluids which move said shift ring between first and second operative positions, said shift ring further including inner and outer gaskets which face in opposite inward and outward radial directions to sealingly contact said first and second seal components, said shift ring being movable axially by a relative difference between said first and second fluid pressures so as to be in said first operative position adjacent said first seal component when said first fluid pressure is higher than said second fluid pressure, and be in said second operative position adjacent said second seal component when said second fluid pressure is higher than said first fluid pressure, said outer gasket defining said balance diameter in a first radial position when said shift ring is in said first operative position, and said inner gasket defining said balance diameter in a second radial position when said shift ring is in said second operative position wherein said balance diameter is in said first radial position when said first fluid pressure is greater than said second fluid pressure and said balance diameter shifts radially to said second radial position when the relative pressure difference between said first and second fluid pressure reverses and said second fluid pressure becomes greater than said first fluid pressure.

12. The mechanical seal according to claim 11, wherein said balance diameter shifts radially inwardly as said shift ring moves axially from said first operative position to said second operative position, and said balance diameter shifts radially outwardly as said shift ring moves axially from said second operative position to said first operative position.

13. The mechanical seal according to claim 11, wherein said shift ring includes inner and outer gasket channels which receive said inner and outer gaskets therein.

14. The mechanical seal according to claim 13, wherein said inner and outer gasket channels are closed on opposite ends to define an axial length of each of said inner and outer gasket channels which is larger than said inner and outer gaskets such that said inner and outer gaskets are each displaceable axially within said inner and outer gasket channels between first and second sealing positions.

15. The mechanical seal according to claim 14, wherein said inner and outer gaskets are shifted to said first sealing position when said first fluid pressure is greater than said second fluid pressure, and are shifted to said second sealing position when said second fluid pressure is greater than said first fluid pressure.

16. The mechanical seal according to claim 11, wherein said inner and outer gaskets shift axially to said second sealing position as said shift ring shifts axially to said second operative position when the relative pressure difference reverses to a reversed pressure condition, and said inner and outer gaskets shift axially to said first sealing position as said shift ring shifts axially to said first operative position when said relative pressure difference returns to a normal pressure condition.

17. The mechanical seal according to claim 11, wherein said shift ring includes opposite first and second end faces which abut against said first and second seal components when in said first and second operative positions.

18. The mechanical seal according to claim 17, wherein said first and second end faces include recessed portions which define an axial space between said shift ring and each of said first and second seal components which respectively receive said first and second pressurized fluids to generate an initial starting force during changes in the relative pressure difference to initiate movement of said shift ring.

19. In a mechanical seal for sealing an annular sealing space between a housing and an axially-elongated rotatable shaft, said mechanical seal including a plurality of annular seal components surrounding said shaft wherein said seal components comprise a gland mountable to said housing, a first seal ring non-rotatably mounted on said gland, a shaft sleeve mountable to said shaft, and a second seal ring non-rotatably mounted on said shaft sleeve so as to rotate with said shaft, said first and second seal rings having opposing seal faces disposed in sealing relation with each other to define a sealing region extending radially along said seal faces, said sealing region radially separating a first chamber with a first pressurized fluid at a first fluid pressure from a second chamber with a second pressurized fluid at a second fluid pressure different than said first fluid pressure, comprising the improvement wherein:
a secondary seal is provided between a first one of said seal components and a second one of said seal components to prevent leakage between said first and second chambers through a secondary flow path defined between said first and second seal components, said first and second seal components having respective first and channel portions which each opens radially and axially toward the other of said first and second seal components wherein said first and second channel portions define an annular channel formed radially and axially between said first and second seal components; and
said secondary seal comprising a balance shift mechanism disposed within said annular channel for preventing fluid leakage through said annular channel while defining a balance diameter of said seal faces, said balance shift mechanism comprising a shift ring which is received in said annular channel so as to be axially movable therein between first and second operative positions, said shift ring having opposite first and second end faces which face axially and are respectively exposed to said first and second pressurized fluids, said shift ring further including inner and outer gasket channels which face radially inwardly and radially outwardly wherein said balance shift mechanism comprises first and second gaskets received in said inner and outer gasket channels which sealingly contact said first and second seal components within said annular channel, said first end face of said shift ring being in contact with said first seal component when said first fluid pressure is higher than said second fluid pressure which moves said shift ring to said first operative position, and said second end face of said shift ring being in contact with said second seal component when said second fluid pressure is higher than said first fluid pressure which moves said shift ring to said second operative position.

20. The mechanical seal according to claim 19, wherein said outer gasket defines a balance diameter in a first radial position when said shift ring is in said first operative position, and said inner gasket defining said balance diameter in a second radial position when said shift ring is in said second operative position wherein said balance diameter is in said first radial position when said first fluid pressure is greater than said second fluid pressure and said balance diameter shifts radially to said second radial position when the relative pressure difference between said first and second fluid pressure reverses and said second fluid pressure becomes greater than said first fluid pressure.

21. The mechanical seal according to claim 19, wherein said inner and outer gasket channels are closed on opposite ends to define an axial length of each of said inner and outer gasket channels which is larger than said inner and outer gaskets such that said inner and outer gaskets are each displaceable axially within said inner and outer gasket channels between first and second sealing positions.

22. The mechanical seal according to claim 21, wherein said inner and outer gaskets are shifted to said first sealing position when said first fluid pressure is greater than said second fluid pressure, and are shifted to said second sealing position when said second fluid pressure is greater than said first fluid pressure.

23. The mechanical seal according to claim 19, wherein said first and second end faces include recessed portions which define an axial space between said shift ring and each of said first and second seal components which respectively receive said first and second pressurized fluids to generate an initial starting force during changes in the relative pressure difference to initiate movement of said shift ring.

24. The mechanical seal according to claim 19, wherein said second seal component is said gland and said first seal component is a support member which supports said first seal ring.

25. In a mechanical seal for sealing an annular sealing space between a housing and an axially-elongate rotatable shaft, said mechanical seal including a plurality of annular seal components surrounding said shaft wherein said seal components comprise a gland mountable to said housing, a support member which is axially movable relative to said gland, a first seal ring non-rotatably mounted on said support member, and a second seal ring non-rotatably mounted on said shaft so as to rotate therewith, said support ring and said first seal ring being axially movable relative to said gland and being normally biased toward said second seal ring, said first and second seal rings having opposing seal faces disposed in sealing relation with each other to define a sealing region extending radially along said seal faces, said sealing region radially separating a first chamber with a first pressurized fluid at a first fluid pressure from a second chamber with a second pressurized fluid at a second fluid pressure different than said first fluid pressure, comprising the improvement wherein:
a secondary seal is provided between said gland and said support member to prevent leakage therebetween, said gland and said support member having respective channel portions which each opens radially and axially toward the other to define an annular channel; and
said secondary seal comprising a balance shift mechanism disposed within said annular channel for preventing fluid leakage through said annular channel while defining a balance diameter of said seal faces, said balance shift mechanism comprising a shift ring which is received in said annular channel so as to be axially movable therein between first and second operative positions, said shift ring further including inner and outer gasket channels which face radially inwardly and radially outwardly wherein said balance shift mechanism comprises first and second gaskets received in said inner and outer gasket channels which sealingly contact said support member and said support gland, said shift ring being in contact with said support member when said first fluid pressure is higher than said second fluid pressure which moves said shift ring to said first operative position, and said shift ring being in contact with said gland when said second fluid pressure is higher than said first fluid pressure which moves said shift ring to said second operative position;
wherein said inner gasket defines a static seal and said outer gasket defines a dynamic seal with said gland so as to slide axially along said gland during axial movements of said support member and said first seal ring, and wherein after movement of said shift ring to said second operative position, said outer gasket defines a static seal and said inner gasket defines a dynamic seal with said support member so as to slide axially along said support member during axial movements of said support member and said first seal ring.

26. The mechanical seal according to claim 25, wherein said shift ring has opposite first and second end faces which face axially and are respectively exposed to said first and second pressurized fluids to effect movement between said first and second operative positions in response to reversing changes in said relative pressure difference.

27. The mechanical seal according to claim 26, wherein said first and second end faces include recessed portions which define an axial space between said shift ring and each of said support ring and said gland which respectively receive said first and second pressurized fluids to generate an initial starting force during reversing changes in the relative pressure difference to initiate movement of said shift ring.

28. The mechanical seal according to claim 27, wherein at least one of said first and second seal rings is axially movable relative to the other of said first and second seal rings and said support member being biased axially toward the second seal ring but being movable away therefrom.

29. In a mechanical seal for sealing an annular sealing space between a housing and an axially-elongate rotatable shaft, said mechanical seal defining a sealing region radially separating a first chamber with a first pressurized fluid at a first fluid pressure from a second chamber with a second pressurized fluid at a second fluid pressure different than said first fluid pressure, comprising the improvement wherein:
a secondary seal is provided between first and second seal components to prevent leakage between said first and second seal components, said first and second seal components having respective channel portions which each opens radially and axially toward the other to define an annular channel; and
said secondary seal comprising a balance shift mechanism disposed within said annular channel for preventing fluid leakage through said annular channel while controlling a fluid pressure balance within said mechanical seal, said balance shift mechanism comprising a shift ring which is received in said annular channel so as to be axially movable therein between first and second operative positions, said shift ring further including inner and outer gasket channels which face radially inwardly and radially outwardly wherein said balance shift mechanism comprises first and second gaskets received in said inner and outer gasket channels which sealingly contact said first and second seal components, said shift ring being in contact with said first seal component when said first fluid pressure is higher than said second fluid pressure which moves said shift ring to said first operative position, and said shift ring being in contact with said second seal component when said second fluid pressure is higher than said first fluid pressure which moves said shift ring to said second operative position.

30. The mechanical seal according to claim 29, wherein said inner gasket defines a static seal and said outer gasket defines a dynamic seal with said second seal component so as to slide axially along said second seal component during axial movements of said first seal component, and wherein after movement of said shift ring to said second operative position, said outer gasket defines a static seal and said inner gasket defines a dynamic seal with said first seal component so as to slide axially along said first seal component during axial movements thereof relative to said second seal component.

31. The mechanical seal according to claim 30, wherein said inner and outer gasket channels are closed on opposite ends to define an axial length of each of said inner and outer gasket channels which is larger than said inner and outer gaskets such that said inner and outer gaskets are each displaceable axially within said inner and outer gasket channels between first and second sealing positions.

32. The mechanical seal according to claim 30, wherein said inner and outer gaskets are shifted to said first sealing position when said first fluid pressure is greater than said second fluid pressure, and are shifted to said second sealing position when said second fluid pressure is greater than said first fluid pressure.
